(19) United States
(12) Patent Application Publication
(10) Pub. No.: US 2026/0171818 A1
(43) Pub. Date: Jun. 18, 2026

(54) CONTROL DEVICE AND OPERATION METHOD THEREOF

(71) Applicant: MEDIATEK INC., Hsinchu City (TW)

(72) Inventors: Cheng-Hsiung HUANG, Hsinchu City (TW); Ting-Hsiang HSIEH, Hsinchu City (TW); Yu-Chia CHANG, Hsinchu City (TW); Chun-Te TUNG, Hsinchu City (TW); Min-Foung HSIEH, Hsinchu City (TW)

(21) Appl. No.: 18/979,847

(22) Filed: Dec. 13, 2024

(51) Int. Cl. H02J 7/00; G06F 1/28

(52) U.S. Cl. CPC H02J 7/62; G06F 1/28; H02J 7/42

(57) ABSTRACT

An embodiment of the disclosure provides a control device, which includes a signal receiving pin and at least one processing module. The signal receiving pin is suitable to couple to the signal transmission pin of a charging module. The signal receiving pin is configured to receive an instruction signal generated by the signal transmission pin in response to the charging module detecting whether the system current reaches an over current protection value or a system voltage reaches the under voltage protection value. The at least one processing module is coupled to the signal receiving pin. The at least one processing module is configured to throttle the frequency of the at least one processing module according to the instruction signal received by the signal receiving pin.

### BACKGROUND OF THE DISCLOSURE

### Field of the Disclosure

The disclosure relates to a control device, and, in particular, it relates to a control device and an operation method thereof.

### Description of the Related Art

Generally, when system current is too high, an over current operation (OCP) or an under voltage lock-out (UVLO) protection will be triggered, causing the system to power down and shut down. This may impact user experience and reduce the convenience of use. Therefore, a new design for a circuit structure is needed to solve the problem described above.

### BRIEF SUMMARY OF THE DISCLOSURE

The disclosure provides a control device and an operation method thereof, thereby effectively preventing a system from powering down and shutting down due to excessive system current, and increasing the user experience and the convenience of use.

An embodiment of the disclosure provides a control device, which includes a signal receiving pin and at least one processing module. The signal receiving pin is suitable to couple to a signal transmission pin of a charging module. The signal receiving pin is configured to receive an instruction signal generated by the signal transmission pin in response to the charging module detecting whether a system current reaches an over current protection value or a system voltage reaches a under voltage protection value. The at least one processing module is coupled to the signal receiving pin. The at least one processing module is configured to throttle a frequency of the at least one processing module according to the instruction signal received by the signal receiving pin.

An embodiment of the disclosure provides an operation method of a control device, which includes the following steps. A signal receiving pin is provided to suitable to couple to a signal transmission pin of a charging module. At least one processing module is provided to couple to the signal receiving pin. The signal receiving pin is used to receive an instruction signal generated by the signal transmission pin in response to the charging module detecting whether a system current reaches an over current protection value or a system voltage reaches an under voltage protection value. The at least one processing module is used to throttle a frequency of the at least one processing module according to the instruction signal received by the signal receiving pin.

According to the control device and the operation method thereof disclosed by the disclosure, the signal receiving pin is suitable to couple to the signal transmission pin of the charging module. The signal receiving pin receives the instruction signal generated by the signal transmission pin in response to the charging module detecting whether the system current reaches the over current protection value or the system voltage reaches the under voltage protection value. The at least one processing module throttles the frequency of the at least one processing module according to the instruction signal received by the signal receiving pin. Therefore, it may effectively prevent a system from powering down and shutting down due to excessive system current, and increase the user experience and the convenience of use.

### BRIEF DESCRIPTION OF THE DRAWINGS

The disclosure can be more fully understood by reading the subsequent detailed description and examples with references made to the accompanying drawings, wherein:

FIG. 1 is a schematic view of a control device according to an embodiment of the disclosure;

FIG. 2 is a waveform diagram view of a system voltage, an instruction signal and a triggering signal according to an embodiment of the disclosure;

FIG. 3 is a waveform diagram of a system current and an instruction signal according to an embodiment of the disclosure;

FIG. 4 is a schematic view of an electronic device according to an embodiment of the disclosure;

FIG. 5 is a flowchart of an operation method of a control device according to an embodiment of the disclosure; and

FIG. 6 is a flowchart of an operation method of a control device according to another embodiment of the disclosure.

### DETAILED DESCRIPTION OF THE DISCLOSURE

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, a person skilled in the art would selectively implement all or some technical features of any embodiment of the disclosure or selectively combine all or some technical features of the embodiments of the disclosure.

In each of the following embodiments, the same reference number represents the same or a similar element or component.

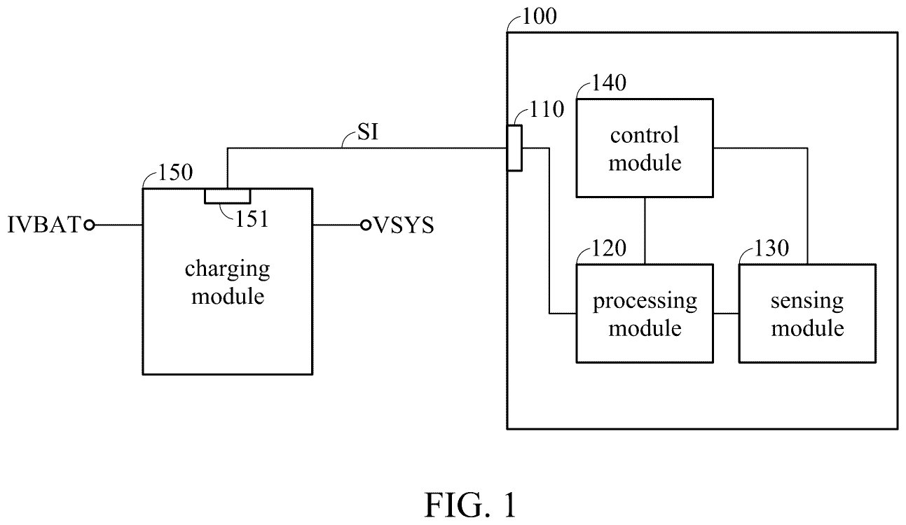

FIG. 1 is a schematic view of a control device according to an embodiment of the disclosure. In the embodiment, the control device 100 may be a system on a chip (SOC), but the disclosure is not limited thereto. Please refer to FIG. 1. The control device 100 may at least include a signal receiving pin 110 and at least one processing module 120.

The signal receiving pin 110 may be suitable to couple to a signal transmission pin 151 of a charging module 150. The signal receiving pin 110 may receive an instruction signal SI generated by the signal transmission pin 151 in response to the charging module 150 detecting whether a system current IVBAT reaches an over current protection value or a system voltage VSYS reaches an under voltage protection value. That is, the charging module 150 may detect the system current IVBAT or the system voltage VSYS, and generate corresponding instruction signal SI through the signal transmission pin 150 according to the state of the system current IVBAT or the system voltage VSYS.

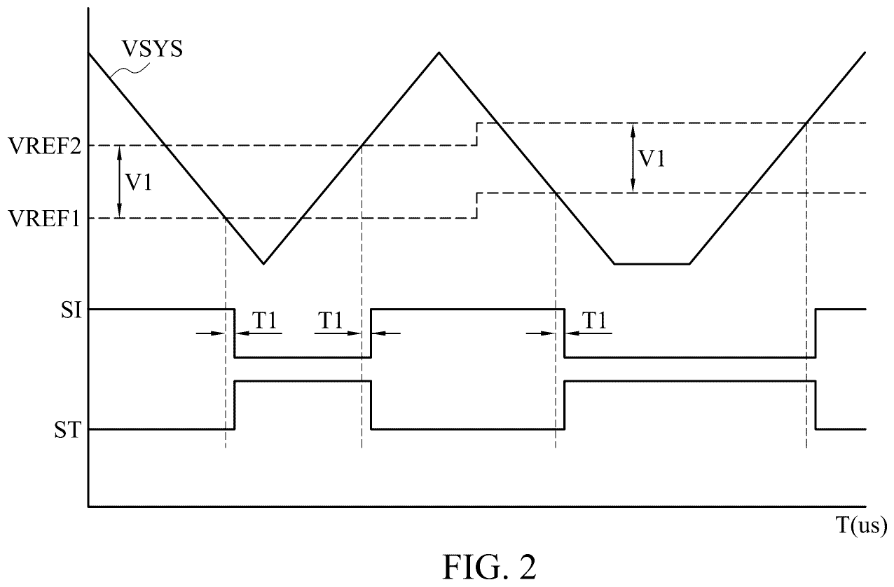

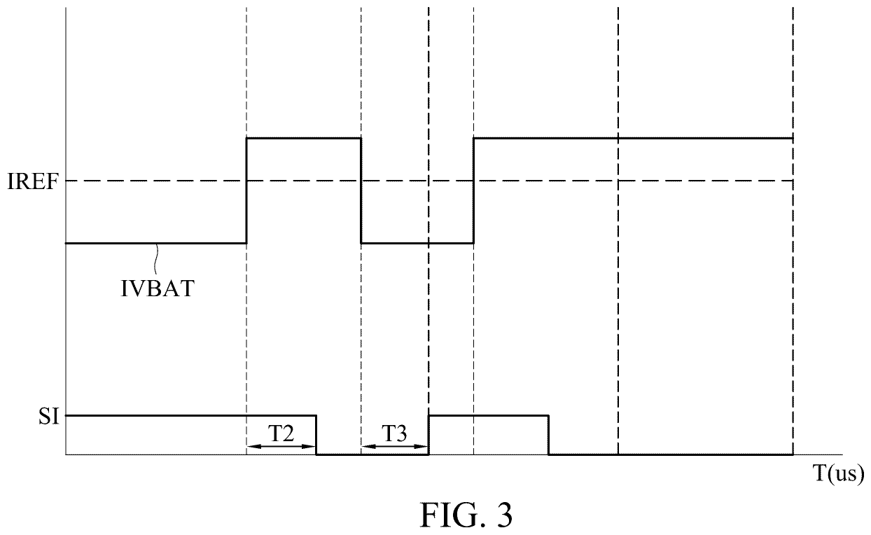

In some embodiments, as shown in FIG. 2 or FIG. 3, when the charging module 150 detects that the system current IVBAT reaches the over current protection value IREF or the system voltage VSYS reaches the under voltage protection value VREF1, in response to the charging module 150 detecting that the system current IVBAT reaches the over current protection value IREF or the system voltage VSYS reaches the under voltage protection value VREF1, the instruction signal SI generated by the signal transmission pin 151 may be a first voltage level.

In some embodiment, when the charging module 150 detects that the system current IVBAT does not reach the over current protection value IREF or the system voltage VSYS does not reach the under voltage protection value VREF1, in response to the charging module 150 detecting that the system current IVBAT does not reach the over current protection value IREF or the system voltage VSYS does not reach the under voltage protection value VREF1, the instruction signal SI generated by the signal transmission pin 151 may be a second voltage level.

In addition, in the embodiment, the first voltage level may be different from the second voltage level. In some embodiments, the first voltage level may be, for example, a low voltage level “L”, and the second voltage level may be, for example, a high voltage level “H”, but the disclosure is not limited thereto.

The at least one processing module 120 may be coupled to the signal receiving pin 110. The at least one processing module 120 may throttle the frequency of the at least one processing module 120 according to the instruction signal SI received by the signal receiving pin 110. In some embodiments, the at least one processing module 120 may be a central processing unit (CPU) or a graphics processing unit (GPU), but the disclosure is not limited thereto.

In some embodiments, when the instruction signal IS generated by the signal transmission pin 151 is the first voltage level (such as the low voltage level “L”), the at least one processing module 120 may throttle the frequency of the at least one processing module 120 to a predetermined frequency. In addition, when the instruction signal SI generated by the signal transmission pin 151 is the second voltage level (such as the high voltage level “H”), the at least one processing module 120 may not throttle the frequency of the at least one processing module 120. In some embodiments, the predetermined frequency is, for example, the minimum operation frequency of the at least one processing module 120, but the disclosure is not limited thereto.

In some embodiments, in an entire operation of the control device 100, as shown in FIG. 2, the charging module 150 may detect whether the system voltage VSYS reach the under voltage protection value VREF1. When the charging module 150 detects that the system voltage VSYS does not reach the under voltage protection value VREF1, the charging module 150 may generate a triggering signal ST with a low voltage level “L”, the instruction signal SI generated by the signal transmitting pin 151 of the charging module 150 may the second voltage level (such as the high voltage level “H”). That is, it means that the system does not need to enter an under voltage lock-out protection. Then, the instruction signal SI with the second voltage level (such as the high voltage level “H”) may be transmitted to the signal receiving pin 110, so that the at least one processing module 120 does not throttle the frequency of the at least one processing module 120.

Afterward, the system voltage VSYS is gradually decreased. When the charging module 150 detects that the system voltage VSYS reaches the under voltage protection value VREF1 (for example, the system voltage VSYS is equal to or less than the under voltage protection value VREF1), the charging module 150 may generate the triggering signal ST with a high voltage level “H”, so that the instruction signal SI generated by the signal transmitting pin 151 of the charging module 150 changes to the first voltage level (such as the low voltage level “L”) from the second voltage level (such as the high voltage level “H”) in a first predetermined time T1. That is, it means that the system needs to enter the under voltage lock-out protection. In some embodiments, the first predetermined time T1 is, for example, 10 us, but the disclosure is not limited thereto. Then, the instruction signal SI with the first voltage level (such as the low voltage level “L”) may be transmitted to the signal receiving pin 110, so that the at least one processing module 120 throttles the frequency of the at least one processing module 120.

Afterward, the system voltage VSYS is not decreased and is gradually increased. When the charging module 150 detects that the system voltage VSYS reaches the under voltage protection releasing value VREF2 (for example, the system voltage VSYS is equal to or greater than the under voltage protection releasing value VREF2), the charging module 150 may generate the triggering signal ST with the low voltage level “L”, so that the instruction signal SI generated by the signal transmitting pin 151 of the charging module 150 changes to the second voltage level (such as the high voltage level “H”) from the first voltage level (such as the low voltage level “L”) in the first predetermined time T1. That is, it means that the system does not need to enter the under voltage lock-out protection. Then, the instruction signal SI with the second voltage level (such as the high voltage level “H”) may be transmitted to the signal receiving pin 110, so that the at least one processing module 120 stops throttling the frequency of the at least one processing module 120 and immediately releases the limit of the frequency of the at least one processing module 120.

In some embodiments, the under voltage protection releasing value VREF2 may be, for example, higher than the under voltage protection value VREF1. In addition, there is a voltage difference V1 between the under voltage protection releasing value VREF2 and the under voltage protection value VREF1. Furthermore, in some embodiments, the voltage difference V1 may be, for example, 200 mV to 300 mV, but the disclosure is not limited thereto.

In some embodiments, in an entire operation of the control device 100, as shown in FIG. 3, the charging module 150 may detect whether the system current IVBAT reaches the over current protection value IREF. When the charging module 150 detects that the system current IVBAT does not reach the over current protection value IREF, the charging module 150 may generate a triggering signal with a low voltage level “L”, so that the instruction signal SI generated by the signal transmitting pin 151 of the charging module 150 is the second voltage level (such as the high voltage level “H”). That is, it means that the system does not need to enter the over current protection. Then, the instruction signal SI with the second voltage level (such as the high voltage level “H”) may be transmitted to the signal receiving pin 110, so that the at least one processing module 120 does not throttle the frequency of the at least one processing module 120.

Afterward, the system current IVBAT is increased. When the charging module 150 detects that the system current IVBAT reaches the over current protection value IREF (for example, the system current IVBAT is equal to or greater than the over current protection value IREF), the charging module 150 may generate the triggering signal with a high voltage level “H”, so that the instruction signal SI generated by the signal transmitting pin 151 of the charging module 150 changes to the first voltage level (such as the low voltage level “L”) from the second voltage level (such as the high voltage level “H”) in a second predetermined time T2. In some embodiments, the second predetermined time T2 may be, for example, 1 us, 10 us, 15 us or 20 us, but the disclosure is not limited thereto. That is, it means that the system needs to enter the over current protection. Then, the instruction signal SI with the first voltage level (such as the low voltage level “L”) may be transmitted to the signal receiving pin 110, so that the at least one processing module 120 throttles the frequency of the at least one processing module 120.

Afterward, the system current IVBAT is decreased. When the charging module 150 detects that the system current IVBAT does not reach the over current protection value IREF (for example, the system current IVBAT is less than the over current protection value IREF), the charging module 150 may generate the triggering signal with the low voltage level “L”, so that the instruction signal SI generated by the signal transmitting pin 151 of the charging module 150 changes to the second voltage level (such as the high voltage level “H”) from the first voltage level (such as the low voltage level “L”) in a third predetermined time T3. In some embodiments, the third predetermined time T3 may be, for example, 30 us, but the disclosure is not limited thereto. That is, it means that the system does not need to enter the over current protection. Then, the instruction signal SI with the second voltage level (such as the high voltage level “H”) may be transmitted to the signal receiving pin 110, so that the at least one processing module 120 stops throttling the frequency of the at least one processing module 120 and immediately releases the limit of the frequency of the at least one processing module 120.

In some embodiments, the control device 100 may further include at least one sensing module 130 and a control module.140. The at least one sensing module 130 may be coupled to the at least one processing module 120. The at least one sensing module 130 may sense a current of at least one processing module 120 to generate a sensing signal.

The control module 140 may be coupled to the at least one processing module 120 and the at least one sensing module 130. The control module 140 may receive the sensing signal, and generated a control signal to the at least one processing module 120 according to the sensing signal, so that the at least one processing module 120 throttles the frequency of the at least one processing module 120 according to control signal and the instruction signal SI.

In some embodiments, when the instruction signal SI generated by the signal transmission pin 151 is the first voltage level (such as the low voltage level “L”), the control module 140 may gradually decrease the frequency of the at least one processing module 120 according to the control signal and the instruction signal SI until the frequency of the at least one processing module 120 reaches the predetermined frequency.

For example, when the instruction signal SI generated by the signal transmission pin 151 is the first voltage level (such as the low voltage level “L”), the at least one processing module 120 may decrease the frequency of the at least one processing module 120 to a first frequency according to the control signal and the instruction signal SI. Then, after a fourth predetermined time, the at least one processing module 120 may decrease the frequency of the at least one processing module 120 to a second frequency from the first frequency according to the control signal and the instruction signal SI. Afterward, after the fourth predetermined time, the at least one processing module 120 may decrease the frequency of the at least one processing module 120 to a third frequency from the second frequency according to the control signal and the instruction signal SI until the frequency of the at least one processing module 120 reaches the predetermined frequency.

In some embodiments, the first frequency is, for example, higher than the second frequency, the second frequency is, for example, higher than the third frequency, and the third frequency is, for example, higher than, the predetermined frequency, but the disclosure is not limited thereto. In some embodiments, the fourth predetermined time is, for example, 30 us, but the disclosure is not limited thereto.

In FIG. 1, the number of at least one processing module 120 and the number of at least one sensing module 130 are one, but the disclosure is not limited thereto. In other embodiments, the number of at least one processing module 120 and the number of at least one sensing module 130 may be two or more, and the coupling relationship and the operation of the two or more processing modules 120 and the two or more sensing module 130 may refer to description of the above embodiment of the at least one processing module 120 and the least one sensing module 130, and the description thereof is not repeated herein. In addition, two or more processing modules 120 may be the same or different.

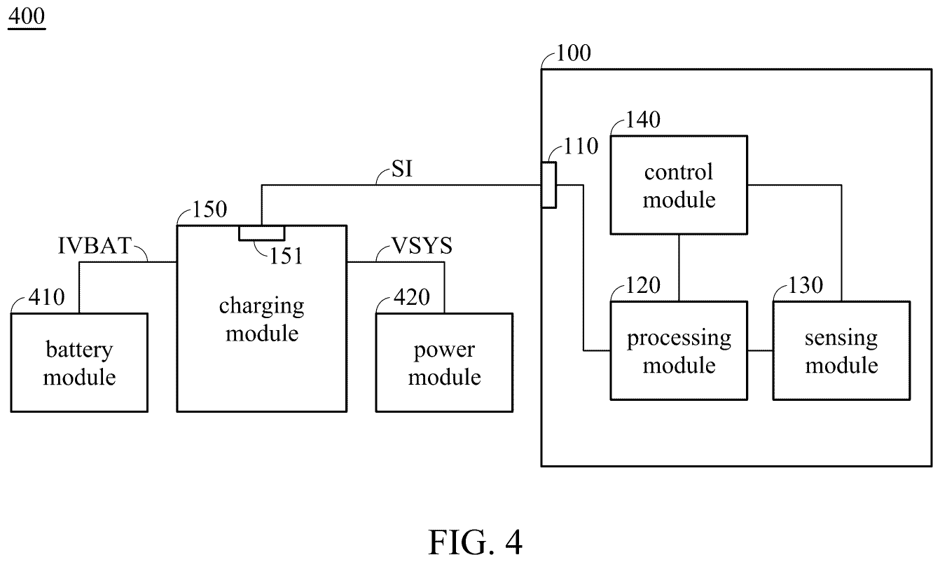

FIG. 4 is a schematic view of an electronic device according to an embodiment of the disclosure. In the embodiments, the electronic device 400 may be a smart phone, a personal computer, a notebook computer, etc., but the disclosure is not limited thereto. Please refer to FIG. 4. The electronic device 400 may include a control device 100, a charging module 150, a battery module 410 and at least one power module 420.

The control device 100 may include a signal receiving pin 110, at least one processing module 120, at least one sensing module 130 and a control module 140. In the embodiments, the control device 100, the signal receiving pin 110, the at least one processing module 120, the at least one sensing module 130 and a control module 140 in FIG. 4 are the same as or similar to the control device 100, the signal receiving pin 110, the at least one processing module 120, the at least one sensing module 130 and a control module 140 in FIG. 1. Accordingly, the signal receiving pin 110, the at least one processing module 120, the at least one sensing module 130 and a control module 140 in FIG. 4 may refer to the description of the embodiment of FIG. 1, and the description thereof is not repeated herein.

The charging module 150 may include a signal transmission pin 151. In the embodiment, the charging module 150 and the signal transmission pin 151 in FIG. 4 are the same as or similar to the charging module 150 and the signal transmission pin 151 in FIG. 1, and the description thereof is not repeated herein.

The battery module 410 may be coupled to the charging module 150. The battery module 410 may provide a system current IVBAT to the charging module 150, so that the charging module 150 may detect the system current IVBAT. In some embodiments, the battery module 410 may be a charging battery, but the disclosure is not limited thereto.

The at least one power module 420 may be coupled to the charging module 150. The at least one power module 420 may provide a system voltage VSYS to the charging module 150, so that the charging module 150 may detect the system voltage VSYS. In some embodiments, the at least one power module 420 may be a power management integrated circuit (PMIC), but the disclosure is not limited thereto.

In FIG. 4, the number of at least one power module 420 is one, but the disclosure is not limited thereto. In some embodiments, the number of at least one power module 420 may be two or more, and the coupling relationship and the operation of the two or more power modules 420 may refer to the description of the above embodiment of the at least one power module 420, and the description thereof is not repeated herein. In addition, two or more power modules 420 may be the same or different.

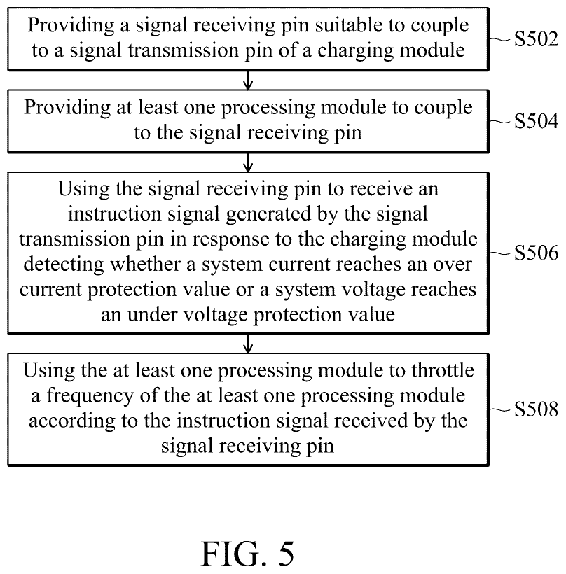

FIG. 5 is a flowchart of an operation method of a control device according to an embodiment of the disclosure. In step S502, the method involves providing a signal receiving pin suitable to couple to a signal transmission pin of a charging module. In step S504, the method involves providing at least one processing module to couple to the signal receiving pin.

In step S506, the method involves using the signal receiving pin to receive an instruction signal generated by the signal transmission pin in response to the charging module detecting whether a system current reaches an over current protection value or a system voltage reaches an under voltage protection value. In step S508, the method involves using the at least one processing module to throttle a frequency of the at least one processing module according to the instruction signal received by the signal receiving pin.

In some embodiments, in response to the charging module detecting that the system current reaches the over current protection value or the system voltage reaches the under voltage protection value, the instruction signal generated by the signal transmission pin is a first voltage level. In addition, in response to the charging module detecting that the system current does not reach the over current protection value or the system voltage does not reach the under voltage protection value, the instruction signal generated by the signal transmission pin is a second voltage level. Furthermore, the first voltage level is different from the second voltage level.

In some embodiments, when the instruction signal generated by the signal transmission pin is the first voltage level, the at least one processing module throttles the frequency of the at least one processing module to a predetermined frequency. In addition, when the instruction signal generated by the signal transmission pin is the second voltage level, the at least one processing module does not throttle the frequency of the at least one processing module.

Furthermore, after the at least one processing module throttles the frequency of the at least one processing module to the predetermined frequency, in response to the charging module detecting that the system current does not reach the over current protection value or the system voltage reaches the under voltage protection releasing value, the instruction signal generated by the signal transmission pin changes to the second voltage level from the first voltage level, so that the at least one processing module stops throttling the frequency of the at least one processing module and releases a limit of the frequency of the at least one processing module. Moreover, in some embodiments, in some embodiments, the predetermined frequency is, for example, the minimum operation frequency of the at least one processing module. In addition, the at least one processing module is, for example, a central processing unit or a graphics processing unit.

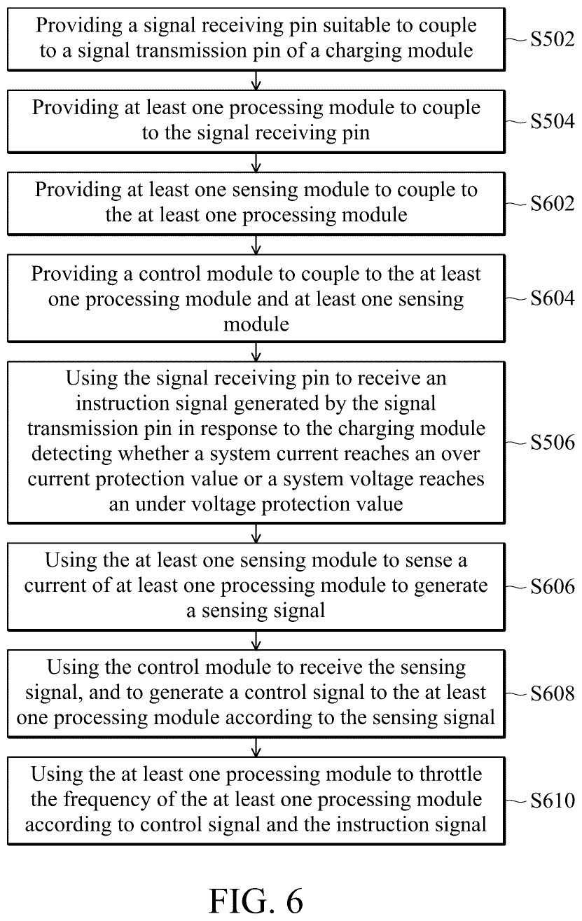

FIG. 6 is a flowchart of an operation method of a control device according to another embodiment of the disclosure. In the embodiment, steps S502˜S506 in FIG. 6 is the same as or similar to steps S502˜S506 in FIG. 5. Accordingly, steps S502˜S506 in FIG. 6 may refer to the description of the embodiment of FIG. 5, and the description thereof is not repeated herein.

In step S602, the method involves providing at least one sensing module to couple to the at least one processing module. In step S604, the method involves providing a control module to couple to the at least one processing module and at least one sensing module.

In step S606, the method involves using the at least one sensing module to sense a current of at least one processing module to generate a sensing signal. In step S608, the method involves using the control module to receive the sensing signal, and to generate a control signal to the at least one processing module according to the sensing signal. In step S610, the method involves using the at least one processing module to throttle the frequency of the at least one processing module according to control signal and the instruction signal.

In some embodiments, step S610 may include using the at least one processing module to gradually decrease the frequency of the at least one processing module according to the control signal and the instruction signal until the frequency of the at least one processing module reaches the predetermined frequency. In addition, in some embodiments, the predetermined frequency is the minimum operation frequency of the at least one processing module.

It should be noted that the order of the steps of FIG. 5 and FIG. 6 is only for illustrative purposes, and is not intended to limit the order of the steps of the present invention. The user may change the order of the steps above to meet specific requirements. The flowcharts described above may add additional steps or use fewer steps without departing from the spirit and scope of the present invention.

In summary, according to the control device and the operation method thereof disclosed by the disclosure, the signal receiving pin is suitable to couple to the signal transmission pin of the charging module. The signal receiving pin receives the instruction signal generated by the signal transmission pin in response to the charging module detecting whether the system current reaches the over current protection value or the system voltage reaches the under voltage protection value. The at least one processing module throttles the frequency of the at least one processing module according to the instruction signal received by the signal receiving pin. Therefore, it may effectively prevent a system from powering down and shutting down due to excessive system current, and increase the user experience and the convenience of use.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control device, comprising:
a signal receiving pin, suitable to couple to a signal transmission pin of a charging module, and configured to receive an instruction signal generated by the signal transmission pin in response to the charging module detecting whether a system current reaches an over current protection value or a system voltage reaches an under voltage protection value; and
at least one processing module, coupled to the signal receiving pin, and configured to throttle a frequency of the at least one processing module according to the instruction signal received by the signal receiving pin.

2. The control device as claimed in claim 1, wherein in response to the charging module detecting that the system current reaches the over current protection value or the system voltage reaches the under voltage protection value, the instruction signal generated by the signal transmission pin is a first voltage level, and in response to the charging module detecting that the system current does not reach the over current protection value or the system voltage does not reach the under voltage protection value, the instruction signal generated by the signal transmission pin is a second voltage level, wherein the first voltage level is different from the second voltage level.

3. The control device as claimed in claim 2, wherein when the instruction signal generated by the signal transmission pin is the first voltage level, the at least one processing module throttles the frequency of the at least one processing module to a predetermined frequency, and when the instruction signal generated by the signal transmission pin is the second voltage level, the at least one processing module does not throttle the frequency of the at least one processing module.

4. The control device as claimed in claim 3, wherein after the at least one processing module throttles the frequency of the at least one processing module to the predetermined frequency, in response to the charging module detecting that the system current does not reach the over current protection value or the system voltage reaches an under voltage protection releasing value, the instruction signal generated by the signal transmission pin changes to the second voltage level from the first voltage level, so that the at least one processing module stops throttling the frequency of the at least one processing module and releases a limit of the frequency of the at least one processing module.

5. The control device as claimed in claim 4, wherein the under voltage protection releasing value is higher than the under voltage protection value.

6. The control device as claimed in claim 3, wherein the predetermined frequency is a minimum operation frequency of the at least one processing module.

7. The control device as claimed in claim 2, further comprising:
at least one sensing module, coupled to the at least one processing module, and configured to sense a current of the at least one processing module to generate a sensing signal;
a control module, coupled to the at least one processing module and the at least one sensing module, and configured to receive the sensing signal, and
generate a control signal to the at least one processing module according to the sensing signal, so that the at least one processing module throttles the frequency of the at least one processing module according to the control signal and the instruction signal.

8. The control device as claimed in claim 7, wherein the at least one processing module gradually decreases the frequency of the at least one processing module according to the control signal and the instruction signal until the frequency of the at least one processing module reaches a predetermined frequency.

9. The control device as claimed in claim 8, wherein the predetermined frequency is a minimum operation frequency of the at least one processing module.

10. The control device as claimed in claim 1, wherein the at least one processing module is a central processing unit or a graphics processing unit.

11. An operation method of a control device, comprising:
providing a signal receiving pin suitable to couple to a signal transmission pin of a charging module;
providing at least one processing module to couple to the signal receiving pin;
using the signal receiving pin to receive an instruction signal generated by the signal transmission pin in response to the charging module detecting whether a system current reaches an over current protection value or a system voltage reaches a under voltage protection value; and
using the at least one processing module to throttle a frequency of the at least one processing module according to the instruction signal received by the signal receiving pin.

12. The operation method of the control device as claimed in claim 11, wherein in response to the charging module detecting that the system current reaches the over current protection value or the system voltage reaches the under voltage protection value, the instruction signal generated by the signal transmission pin is a first voltage level, and in response to the charging module detecting that the system current does not reach the over current protection value or the system voltage does not reach the under voltage protection value, the instruction signal generated by the signal transmission pin is a second voltage level, wherein the first voltage level is different from the second voltage level.

13. The operation method of the control device as claimed in claim 12, wherein when the instruction signal generated by the signal transmission pin is the first voltage level, the at least one processing module throttles the frequency of the at least one processing module to a predetermined frequency, and when the instruction signal generated by the signal transmission pin is the second voltage level, the at least one processing module does not throttle the frequency of the at least one processing module.

14. The operation method of the control device as claimed in claim 13, wherein after the at least one processing module throttles the frequency of the at least one processing module to the predetermined frequency, in response to the charging module detecting that the system current does not reach the over current protection value or the system voltage reaches a under voltage protection releasing value, the instruction signal generated by the signal transmission pin changes to the second voltage level from the first voltage level, so that the at least one processing module stops throttling the frequency of the at least one processing module and releases a limit of the frequency of the at least one processing module.

15. The operation method of the control device as claimed in claim 14, wherein the under voltage protection releasing value is higher than the under voltage protection value.

16. The operation method of the control device as claimed in claim 13, wherein the predetermined frequency is a minimum operation frequency of the at least one processing module.

17. The operation method of the control device as claimed in claim 12, further comprising:
providing at least one sensing module to couple to the at least one processing module;
providing a control module to couple to the at least one processing module and at least one sensing module;
using the at least one sensing module to sense a current of at least one processing module to generate a sensing signal; and
using the control module to receive the sensing signal, and to generate a control signal to the at least one processing module according to the sensing signal;
wherein the step of using the at least one processing module to throttle the frequency of the at least one processing module according to the instruction signal received by the signal receiving signal comprises:
using the at least one processing module to throttle the frequency of the at least one processing module according to the control signal and the instruction signal.

18. The operation method of the control device as claimed in claim 17 wherein the step of using the at least one processing module to throttle the frequency of the at least one processing module according to the control signal and the instruction signal comprises:
using the at least one processing module to gradually decrease the frequency of the at least one processing module according to the control signal and the instruction signal until the frequency of the at least one processing module reaches a predetermined frequency.

19. The operation method of the control device as claimed in claim 18, wherein the predetermined frequency is a minimum operation frequency of the at least one processing module.

20. The operation method of the control device as claimed in claim 11, wherein the at least one processing module is a central processing unit or a graphics processing unit.
